(19) United States
(12) Patent Application Publication
(10) Pub. No.: US 2016/0176731 A1
(43) Pub. Date: Jun. 23, 2016

(54) APPARATUS FOR THE PURIFICATION OF UNCLEAN WATER, IN PARTICULAR OF WASTEWATER AND/OR POLLUTED WATER

(71) Applicant: ECO-SISTEMI S.R.L., Rovereto (IT)

(72) Inventor: Sergio Modenese, Lerici (IT)

(21) Appl. No.: 14/907,416

(22) PCT Filed: Jul. 11, 2014
(86) PCT No.: PCT/IB2014/063030

§ 371 Date: Jan. 25, 2016

(30) Foreign Application Priority Data
Jul. 26, 2013 (IT) MI2013A001257

(51) Int. Cl. C02F 3/08; C02F 3/10

(52) U.S. Cl. CPC C02F 3/082; C02F 3/10; C02F 2203/006

(57) ABSTRACT

The invention regards an apparatus (1) for the purification of unclean water (A), in particular of wastewater and/or polluted water (A), comprising:—at least one container (2), preferably cylindrical, delimiting a reaction chamber (3) arranged to receive a predetermined amount of water (A) to be treated; at least one support (11), preferably at least one free body (11a) not constrained to the apparatus (1), operatively arranged inside the reaction chamber (3) of the container (2) and provided with at least one surface for the formation and/or the proliferation of bacterial colonies in form of films capable of purifying unclean water (A), the support (11) periodically emerging, at least partially, from the water (A) to be treated in order to place the bacterial colonies into contact with the air. The container (2) is movable, in particular rotationally about a predetermined rotation axis (X), for periodically driving the support (11) between an immersed condition, wherein it is totally covered with water (A) to be treated, and an emerged condition, wherein it emerges, at least partially, from the water (A) to be treated.

The present invention refers to an apparatus for the purification of unclean water, in particular of wastewater and/or polluted water.

The object of the present invention can be applied to the field of treatment of wastewater and/or polluted water through which the unwanted polluting substances are removed from the liquid manure to be treated.

In particular, the invention is intended for the field of purification of wastewater and/or polluted water through biomasses or similar bacterial colonies in form of films which require suitable supports for the formation and/or proliferation thereof.

As known, the use of biomasses or similar bacterial colonies for the purification of wastewater may be performed through plants or apparatuses with biological discs or through moving bed biofilm reactors.

The plants and the apparatus with biological discs are provided with a plurality of discs, made of plastic material, fixed on a shaft which is placed in rotation.

The discs are partially immersed in the liquid manure to be purified hence the rotation of the shaft causes the contact thereof with the air and with the liquid phase.

During the rotation the micro-organisms are formed and grow on the surface of the disc forming a film of organic material whose thickness progressively increases.

Alternatively, during the rotary motion, the biological film assimilates oxygen in the air exposition stage, before being immersed to adsorb and metabolise the dissolved organic and colloidal substances present in the liquid manure. The film continues to develop until it reaches a limit thickness, before detaching autonomously.

The moving bed biofilm reactors provide for a series of tanks in which the micro-organisms adhere on support means dispersed and suspended in the waste-water to be treated. The support means are moved with air to allow the formed bacterial colonies to come into contact with the oxygen necessary for their respiration.

It is possible to provide that the movement of the support means is performed by suitable air insufflation systems and/or by mechanical mixers suitably present in the tanks. It is also possible that the support means are directly agitated by flows of liquid manure in movement along predetermined paths.

Also in this case the biomasses which form on the support means thicken up to detaching and sedimentation.

Though the known aforedescribed plants and/or reactors allow a satisfactory purification of unclean water, wastewater and/or polluted water, the Applicant observed that they also reveal some drawbacks and they can be improved from different points of view, mainly as regards the excessive encumbrance of the known plants and/or reactors, the maintenance interventions thereon, the overall energy consumptions, as well as the costs of operation and purification of the unclean water.

In particular the Applicant observed that the plants and the biological disc apparatuses are frequently subject to the breaking of the rotary shaft on which there weighs the overall mass of the supported discs further weighed upon by the biological film adhering thereto.

With the aim of overcoming such drawback, the plants and the biological disc apparatuses are considerably over-dimensioned. The over-dimensioning of the shaft causes the unwanted reduction of the areas of the surfaces of the discs intended for the bacterial formation and/or proliferation with negative effects on the overall performance of the purification machines.

The over-dimensioning of the plant also has advantages in energetic terms in that the movement of high masses constituted by a shaft/discs assembly requires considerable energy supply which considerably increases the operating costs of the plant.

On the other hand, with reference to the moving bed biofilm reactors, also such apparatuses reveal high encumbrances and energy consumption in that they require a series of systems for moving the support means arranged in the various collection tanks provided for.

In addition it should be observed that the moving bed biofilm reactors have a particularly complex structure whose continuous maintenance interventions increase the overall costs for the purification of the water to be treated.

The main object of the present invention is to provide for an apparatus for the purification of unclean water, in particular wastewater and/or polluted water, capable of overcoming the problems observed in the prior art.

A further object of the present invention is to provide an apparatus for the purification of unclean water which has a small encumbrance.

Another object of the present invention is to provide an apparatus for the purification of unclean water which requires lesser energy supply with respect to that of prior art.

Providing an apparatus for the purification of unclean water capable of reducing maintenance interventions to the minimum is also an object of the present invention.

A further object of the present invention is to provide an apparatus for the purification of unclean water capable of reducing the overall costs of operation thereof and, hence, the costs related to the corresponding purification treatments.

Providing an apparatus for the purification of unclean water capable of considerably increasing the concentration of the biological surface is also an object of the present invention.

Providing an apparatus for the purification of unclean water that is safe and not revealing hazards for the operators is also an object of the present invention.

A further object of the present invention is to provide an apparatus for the purification of unclean water that is not subject to the disadvantageous aerosol effects due to insufflation of air in the waters to be treated.

These and other objects are substantially attained by an apparatus for the purification of unclean water, in particular wastewater and/or polluted water, as outlined and described in the claims that follow.

In the following there is an exemplifying description of a preferred but non-exclusive embodiment of an apparatus for the purification of unclean water, in particular wastewater and/or polluted water, according to the present invention. Such description shall be carried out hereinafter with reference to the attached drawings, provided solely by way of non-limiting example, wherein:

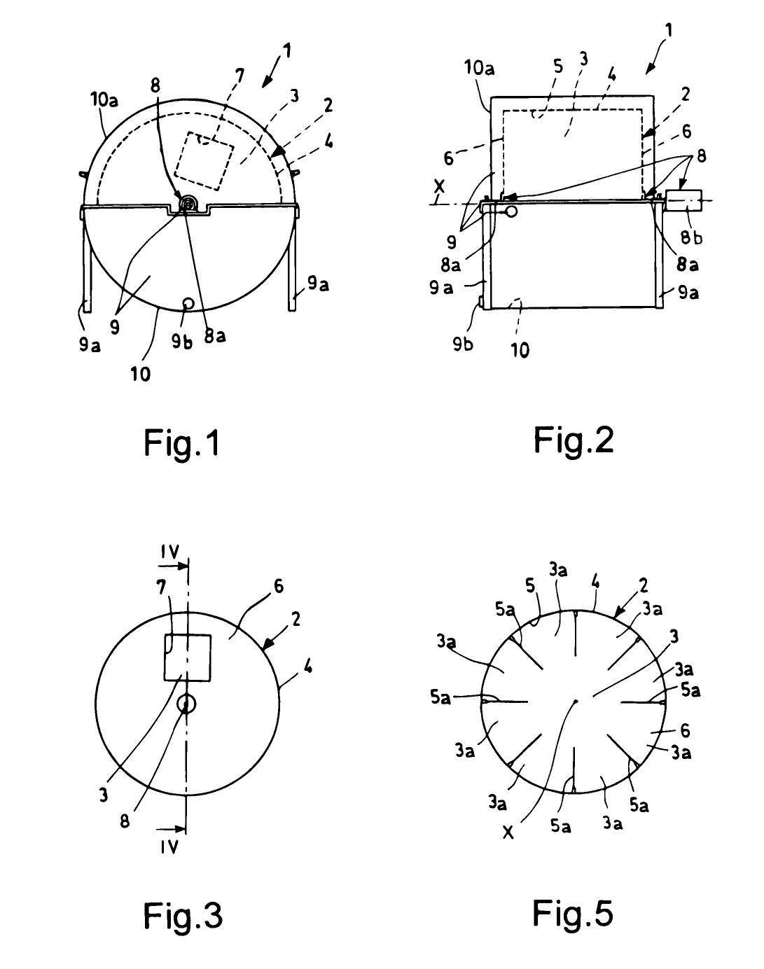

FIG. 1 is an elevational schematic view of an apparatus for the purification of unclean water, in particular wastewater and/or polluted water;

FIG. 2 is a further elevational schematic view of the apparatus of FIG. 1;

FIG. 3 is an elevational schematic view of a detail of the apparatus represented in FIGS. 1 and 2;

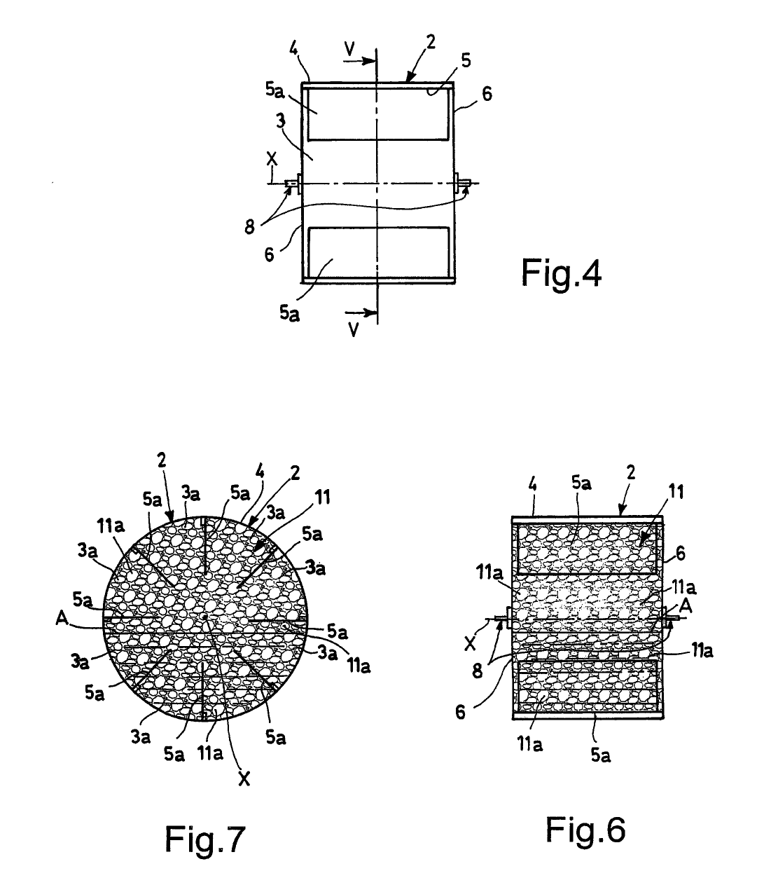

FIG. 4 is a schematic section, in empty condition, of the detail of FIG. 3, obtained along line IV-IV of the same figure;

FIG. 5 is a schematic section, in empty condition, of the detail of FIGS. 3 and 4, obtained along line V-V of FIG. 4;

FIG. 6 is a schematic section identical to the section of FIG. 4 in which the represented detail is shown in operating condition;

FIG. 7 is a schematic section identical to the section of FIG. 5 in which the represented detail is shown in operating condition.

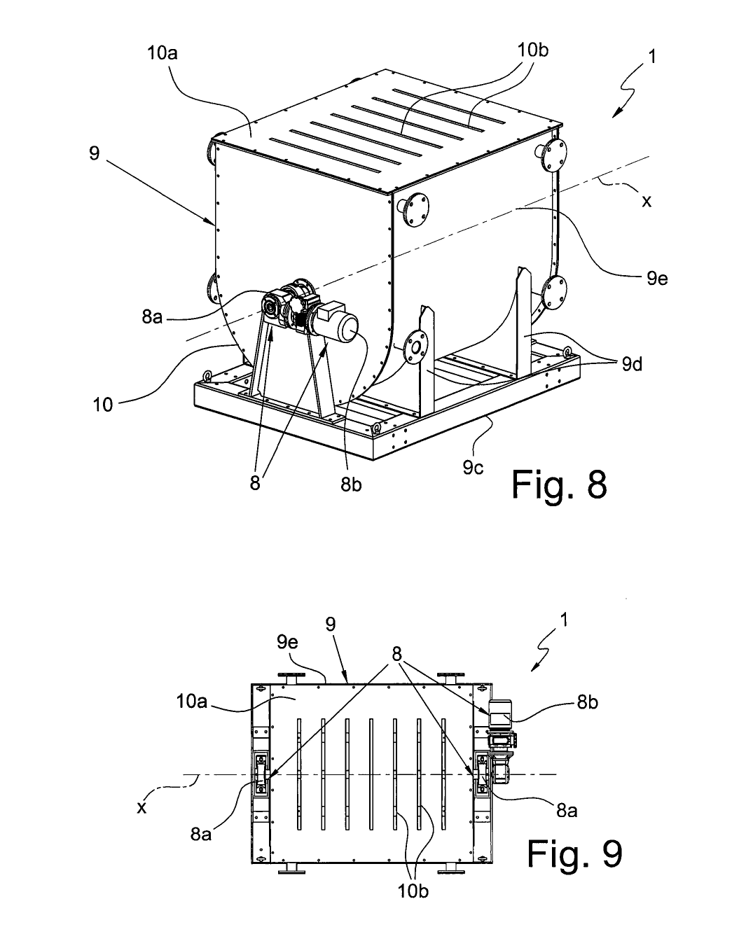

FIG. 8 is a perspective view of an apparatus for the purification of unclean water, in particular wastewater and/or polluted water, according to a further embodiment of the present invention;

FIG. 9 is a top view of the apparatus of FIG. 8;

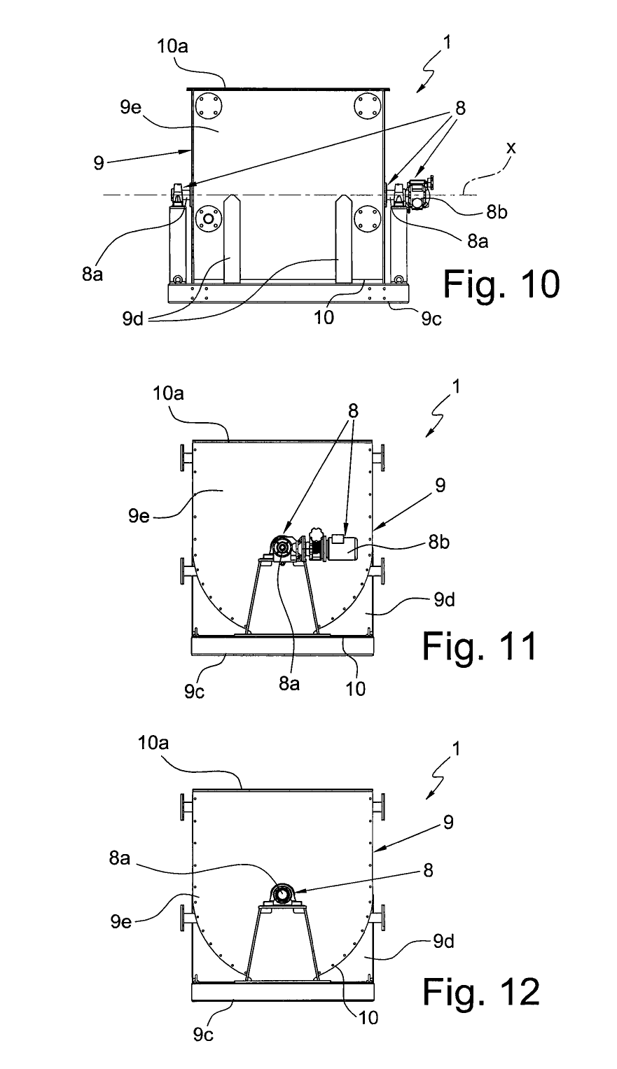

FIGS. 10 to 12 are elevational views of the apparatus illustrated in FIGS. 8 and 9;

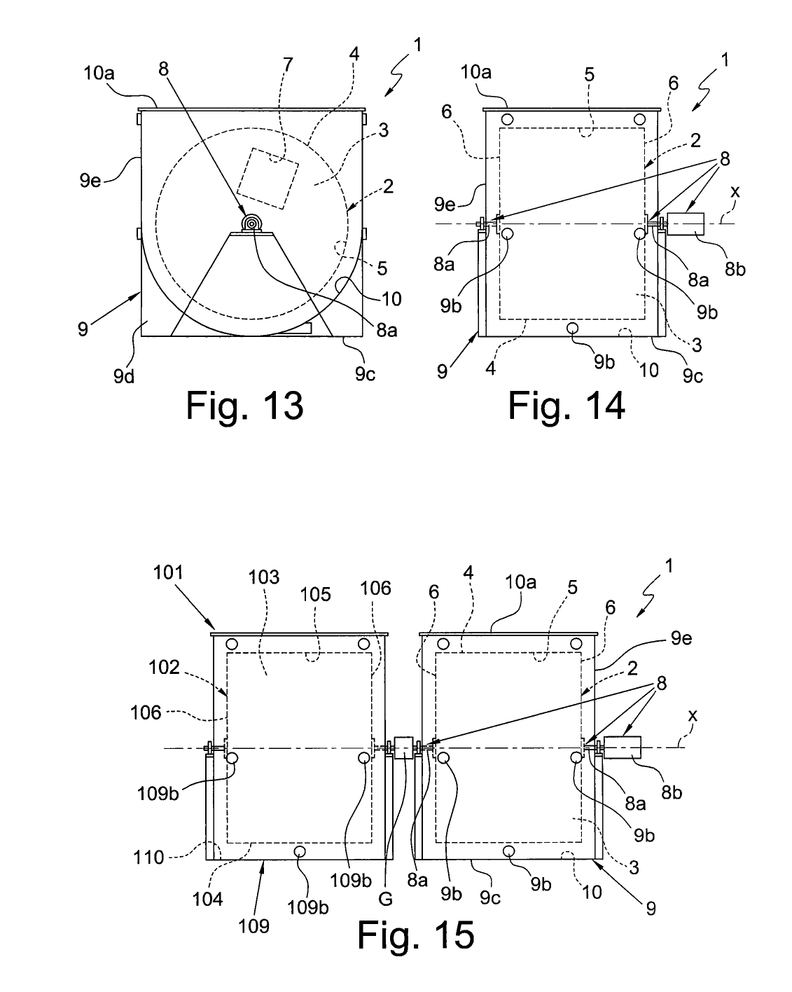

FIGS. 13 and 14 are elevational schematic views of the apparatus according to FIGS. 8 to 12,

FIG. 15 is an elevational schematic view of an apparatus for the purification of unclean water, in particular wastewater and/or polluted water, according to a further embodiment of the present invention.

With reference to the attached figures, an apparatus for the purification of unclean water, in particular wastewater and/or polluted water, according to the present invention is indicated in its entirety with 1.

As observable in FIGS. 1 to 7 and 13 to 15, the apparatus 1 comprises at least one container 2, preferably cylindrical, delimiting a reaction chamber 3 arranged to receive a predetermined amount of water to be treated (FIGS. 6 and 7).

The container 2 comprises a cylindrical wall 4 on which there is defined a cylindrical internal surface 5 (FIGS. 1, 2, 4 to 7 and 13 to 15) and two lateral walls 6 (FIGS. 2, 3, 4, 6 and 13 to 15) which engage the opposite ends of the cylindrical wall 4.

As observable in FIGS. 4 to 7, from the cylindrical internal surface 5 of the container 2 there extends a plurality of radial partitions 5a which divide the reaction chamber 3 in a series of peripheral sectors 3a (FIGS. 5 and 7) distributed along the cylindrical internal surface 5.

Preferably, the cylindrical wall 5 and, hence the cylindrical internal surface 4 has a plurality of through openings (not represented in the attached figures) so as to be permeable to the fluids.

For the purpose of the present invention, the cylindrical wall 5 may be of the closed type and provided with a plurality of through openings so as to circumscribe the content simultaneously being permeable to the fluids or it may be of the open type so that any rotation thereof causes the agitation of the content of the reaction chamber 3.

As observable in FIGS. 1, 3 and 13, the container 2 has at least one access opening 7, preferably obtained at at least one of the lateral walls 6, for access to the reaction chamber 3 defined by the cylindrical 4 and lateral 6 walls. The access opening 7 is closable, during the operation of the apparatus 1, through suitable closing means (not represented in the attached figures).

Advantageously, the container 2 is movable, in particular rotationally about a predetermined rotation axis X (FIGS. 2, from 4 to 10, 14 and 15). The rotation of the container 2 is performed through suitable movement means 8 (FIGS. 1 to 3, 4, 6 and from 8 to 15) operatively connected thereto.

In detail, the movement means 8 comprise a pair of rotary support pins 8a rotationally constrained to a structure 9. The movement means 8 further comprise at least one electrical motor 8b (FIGS. 2, from 8 to 11, 14 and 15) operatively connected to at least one of the rotary support pins 8 to rotatably drive the container 2 about the rotation axis X.

According to the embodiment of FIGS. 1 and 2, the structure 9 which rotationally supports the container 2 has in turn a substantially cylindrical conformation from which suitable support elements 9a extend to the ground.

The structure 9 delimits, in its inside, a closed collection tank 10 for receiving a predetermined amount of impure water, wastewater and/or polluted water A which should be treated and purified.

Advantageously, the collection tank 10 can be flooded at pleasure depending on the needs and the type of process intended to be implemented.

Still with reference to FIGS. 1 and 2, the structure 9 is advantageously provided with a cover 10a which has one or more aeration slots 10b for exchanging oxygen with the outside. The cover 10a is removably engaged to the collection tank 10 to allow the easy opening thereof in case of direct access to the latter.

However, it should be observed that for the purpose of the present invention, the cover 10a may also be removed being the collection tank 10 open at the upper part, or the structure 9 may be made so as to have a collection tank 10 that does not totally contain the vertical encumbrance of the container 2.

Advantageously, the structure 9 is shaped in such a way to receive in its inside, rotationally about the axis X, the aforementioned container 2, which is in fluid communication with the collection tank 10 through the through openings obtained through the cylindrical wall 4 and the cylindrical internal surface 5.

In other words, the through openings of the cylindrical wall 4 of the container 2 allow the water A to be treated present in the collection tank 10 to flood, at least partially, the reaction chamber 3 of the container 2.

According to the embodiment illustrated in FIGS. 8 to 15, the structure 9 which rotationally supports the container 2 is substantially box-shaped.

In detail, the structure 9 has a substantially flat support base 9c from which at least one pair of supports 9d, which supports a hollow body 9e rounded at the lower part and square-shaped at the upper part, extends vertically.

The structure 9 delimits, in its inside, a collection tank 10 for receiving a predetermined amount of impure water, wastewater and/or polluted water A which should be treated and purified.

As observable in FIGS. 8 to 12, the structure 9 is advantageously provided with a cover 10a which has one or more aeration slots 10b for exchanging oxygen with the outside. The cover 10a is removably engaged to the collection tank 10 to allow the easy opening in case of direct access to the latter.

Also in this case, the absence of the cover does not alter the operation of the apparatus 1 in any way whatsoever.

Advantageously, the structure 9 is shaped in such a way to receive in its inside, rotationally about the axis X, the aforementioned container 2, which is in fluid communication with the collection tank 10 by means of the through openings obtained through the cylindrical wall 4 and the cylindrical internal surface 5.

In other words, the through openings of the cylindrical wall 4 of the container 2 allow the water A to be treated present in the collection tank 10 to flood, at least partially, the reaction chamber 3 of the container 2.

According to a further embodiment illustrated in FIG. 5, the apparatus 1 comprises at least one auxiliary purification unit 101, optionally structurally identical to the apparatus 1.

In detail, the auxiliary purification unit 101 comprises at least one container 102, preferably cylindrical, which delimits a reaction chamber 103 arranged to receive a predetermined amount of water to be treated.

The container 102 comprises a cylindrical wall 104 on which there is defined a cylindrical internal surface 105 and two lateral walls 106 which engage the opposite ends of the cylindrical wall 104.

Preferably, the cylindrical wall 105 and hence the cylindrical internal surface 104 has a plurality of through openings (not represented in the attached figures) so as to be permeable to the fluids.

Also in this case, the container 102 has at least one access opening (not visible in FIG. 15), preferably obtained at at least one of the lateral walls 106, for the access to the reaction chamber 103 defined by the cylindrical 104 and lateral 106 walls. The access opening can be hermetically closed, during the operation of the apparatus 1, through appropriate hermetic closing means (not illustrated).

Advantageously, the container 102 is movable, in particular rotationally about a predetermined rotation axis, preferably coinciding with the rotation axis X of the apparatus 1.

It can also be provided for that the container 102, is not completely closed hence the content thereof is not completely circumscribed by the container 102, which thus serves as an agitator.

Also the auxiliary purification unit 101 comprises a structure 109 having the same elements of the structure 9 of the apparatus 1, which defines a tank 110 provided for containing wastewater to be purified and the container 102.

Advantageously, the auxiliary purification unit 101 is operatively connectable to the apparatus 1 through at least one intermediate connection joint G, hence the rotation of the container 2 of the apparatus 1 about the rotation axis X causes the rotation of the container 102 of the auxiliary purification unit 101 about such rotation axis X.

It can also be provided for that the apparatus 1 comprises a plurality of auxiliary purification units 101, optionally structurally identical to the auxiliary purification unit 101 connected to the apparatus 1.

According to such solution the auxiliary purification units 101 are connected to each other through corresponding intermediate connection joints G hence the rotation of the container 2 of the apparatus 1 about the rotation axis X causes the driving in rotation of the respective containers 102 of each auxiliary purification unit 101 about a respective rotation axis, preferably coinciding with the rotation axis X.

Advantageously, the apparatus 1 comprises at least one support 11 (FIGS. 6 and 7), preferably at least one free body not constrained to the apparatus 1, operatively arranged inside the reaction chamber 3 of the container 2 and provided with at least one surface (not illustrated in the attached figures) for the formation and/or the proliferation of bacterial colonies in form of films capable of purifying unclean water, wastewater and/or polluted water.

Preferably, during the operation of the apparatus 1, the support 11 periodically emerges, at least partially, from the water A to be treated which is present inside the reaction chamber 3 in order to place the bacterial colonies which are formed and proliferate thereon in contact with the oxygen.

In the detail, the rotation of the container 2 inside the collection tank 10, periodically moves the support between an immersed condition, in which it is totally covered with water A to be treated, and an emerged condition, in which it emerges, at least partially, from the water A to be treated.

In the immersed condition the bacterial colonies which are formed and proliferate on the surface of support of the support 11 adsorb and metabolise the dissolved and colloidal organic substances present in the water A to be treated, while in the emerged condition, they are exposed to the air being saturated with oxygen.

As observable in FIGS. 6 and 7, the support 11 comprises a plurality of free bodies 11a arranged inside the reaction chamber 3.

Advantageously, the surface of the support 11 is defined at least partially by the surfaces of at least one part of the free bodies 11a present in the reaction chamber 3, preferably by all its surfaces of each free body 11a present in the reaction chamber 3.

According to a preferred aspect of the present invention, the reaction chamber 3 is filled, at least for three fourths of its volume, advantageously completely, with the free bodies 11a, hence the overall support surface of the bacterial colonies is particularly extended.

With the aim of facilitating, on the one hand, the formation and the proliferation of the bacterial colonies and further increasing the overall support surface of the same, each free body 11a has at least one surface, advantageously all its surfaces, coarse, preferably rough and/or knurled and/or provided with surface reliefs.

Advantageously, each free body 11a of the support 11 is made of a plastic material, preferably recyclable, optionally plastic stoppers recovered from plastic bottles.

This aspect is particularly advantageous in that the reutilisation of the stoppers allows to considerably reduce the cost related to providing the aforementioned supports though guaranteeing an optimal support surface for the proliferation of the bacterial colonies essential for the purification of the wastewater and/or unclean water.

With the aim of further increasing the purification effect of the bacterial colonies which develop inside the container 2, the cylindrical internal surface 5 and the radial partitions 5a provide a further auxiliary support surface for the bacterial formation and proliferation, whose portions are periodically immersed in the water A to be treated and exposed to the air present in the reaction chamber 3 during the rotation of the container 2.

According to an advantageous aspect of the present invention, it may be provided that the apparatus 1 is provided with suitable detection means and/or similar sensors (not represented) capable of detecting the quality of the process, intended as the purification quality, in progress, as well as the weight of the sludge that is formed, so as to regulate the flooding of the collection tank 10, 110 and the speed of rotation of the container 2, 102.

According to an advantageous aspect of the present invention, it is also possible to provide that the data detection system is provided with the capacity of transmitting the process information from a remote position.

Advantageously, both the radial partitions and the cylindrical internal surface 5 of the container 2 are coarse, preferably rough and/or knurled and/or provided with reliefs for facilitating the formation of the bacterial colonies and provide a greater support surface thereto.

With the aim of allowing the periodical maintenance operations as well as the discharge of liquid manure the structure 9 is suitably provided with discharge openings 9b, 109b (FIGS. 1 and 2) arranged at the bottom of the collection tank 10, 110.

The previously described apparatus for the purification of unclean water, in particular wastewater and/or polluted water will overcome the problems observed in the prior art and attains great advantages.

First and foremost, the particular configuration of the apparatus described above allows a considerable reduction of the encumbrances as compared to the prior art.

In particular, the elimination of the over-dimensioned shaft and discs assembly considerably contributes to the reduction of the encumbrances of the apparatus.

In addition, the filling of the container with free bodies allows the formation of an overall support surface for the bacterial colonies of considerable extent without requiring unwanted increase of volume.

The elimination of heavy masses in movement allows a considerable reduction of energy consumption of the apparatus during the operation thereof.

Furthermore, even the normal maintenance interventions required in the plants and in the apparatuses of the prior art are thus minimised.

Obviously, the lowering of energy consumptions and the reduction of maintenance interventions cause a considerable reduction of the overall operating costs of the apparatus and, thus, the relative costs for the purification treatments of unclean water.

A further advantage of the apparatus described above lies in obtaining higher concentrations of biological surfaces available in small spaces, in that the free bodies define a support surface which develops in a three-dimensional manner inside the reaction chamber.

In addition, it should be observed that the apparatus according to the present invention is completely isolated from the outside hence it does not have zones hazardous for the operators and the designated personnel operating on the same.

It should be observed that the apparatus subject of the present invention does not have any system or mechanism capable of producing the unwanted aerosol effect mainly present in the reactors which provide for the insufflation of air in the water to be treated.

In addition, it should be observed that the structure of the apparatus mentioned above is quite simple and easy to maintain.

In addition, the possibility of connecting the apparatus to one or more auxiliary purification units exploiting the motor of the apparatus itself, allows to boost its purification capacity thus simultaneously ensuring small encumbrances and reduced consumptions.

1. An apparatus for the purification of unclean water in particular of wastewater and/or polluted water, comprising:
at least one container, preferably cylindrical, delimiting a reaction chamber arranged to receive a predetermined amount of water to be treated;
at least one support operatively arranged inside said reaction chamber of said container and provided with at least one surface for the formation and/or proliferation of bacterial colonies in form of films capable of purifying unclean water, said support periodically emerging, at least partially, from said water to be treated in order to place said bacterial colonies into contact with the air;
characterised in that said support comprises at least one free body not constrained to the apparatus and in that said container is movable, in particular rotationally about a predetermined rotation axis, for periodically driving said support between an immersed condition, wherein it is totally covered by water to be treated, and an emerged condition, wherein it emerges, at least partially, from said water to be treated, said apparatus comprising movement means operatively connected to said container for rotating the latter about said rotation axis, said movement means comprising at least one pair of support pins rotationally constrained to the structure of said apparatus.

2. The apparatus according to claim 1, wherein said support comprises a plurality of free bodies located inside said reaction chamber, said surface of said support being defined at least partially by the surfaces of at least one part of said free bodies present in said reaction chamber, preferably by all surfaces of each free body present in said reaction chamber.

3. The apparatus according to claim 2, wherein said reaction chamber is filled, at least for three fourths of its volume, preferably completely, by said free bodies.

4. The apparatus according to claim 1, wherein each free body of said support has at least one surface being coarse, further wherein the surfaces comprise a rough surface, a knurled surface, a surface comprising a plurality of reliefs; and a combination thereof.

5. The apparatus of claim 1, wherein each free body of said support is made of a plastic material comprising plastic stoppers recovered from plastic bottles.

6. The apparatus of claim 1, wherein said container has a cylindrical inner surface from which a plurality of radial partitions extends, said cylindrical inner surface and said radial partitions defining at least one auxiliary surface for the formation and/or the proliferation of said bacterial colonies, the rotation of said container periodically placing all the parts of said cylindrical inner surface and all radial partitions into contact with the air present in said reaction chamber and with the water to be treated.

7. The apparatus according to claim 6, wherein said radial partitions and said cylindrical inner surface of said container are coarse, further comprising rough portions, knurled portions; surface reliefs; or a combination thereof.

8. The apparatus according of claim 6, comprising a collection tank of said water to he treated shaped in such a way to receive in rotation, at least partially, said container, said cylindrical inner surface of said container having a plurality of through openings in order to place the reaction chamber in fluid communication with said collection tank.

9. The apparatus according to claim 8, wherein said collection tank is defined inside an externally closed structure, comprising a hermetically closed structure.

10. The apparatus according to claim 9, wherein said structure is provided with a cover having one or more aeration slots for exchanging oxygen with the outside, advantageously said cover being removably engaged to the collection tank to allow the easy opening thereof when necessary.

11. The apparatus according to claim 1, comprising at least one auxiliary purification unit, configured to be structurally identical to said apparatus, operatively connectable to the latter through at least one intermediate connection joint, hence the rotation of said container of said apparatus about said rotation axis (X) causes the rotation of a container of said auxiliary purification unit about a corresponding rotation axis, preferably coinciding with the rotation axis (X) of said apparatus.

12. The apparatus according to claim 11, comprising a plurality of auxiliary purification units, optionally structurally identical to said auxiliary purification unit connected to said apparatus, said auxiliary purification units being connected to each other through corresponding intermediate connection joints (G) hence the rotation of said container of said apparatus about said rotation axis causes the rotation of a container of each auxiliary purification unit about a respective rotation axis, preferably coinciding with the rotation axis (X) of said apparatus.

13. An apparatus for the purification of unclean water, in particular of wastewater and/or polluted water, comprising:
at least one cylindrical container, delimiting a reaction chamber arranged to receive a predetermined amount of water to be treated;
at least one support operatively arranged inside said reaction chamber of said container and provided with at least one surface for the formation and/or proliferation of bacterial colonies in form of films capable of purifying unclean water, said support periodically emerging, at least partially, from said water to be treated in order to place said bacterial colonies into contact with the air;
characterised in that said support comprises a plurality of free bodies completely filling the support such that the free bodies in the support are not constrained to the apparatus and in that said container is movable,
in particular rotationally about a predetermined rotation axis, for periodically driving said support between an immersed condition, wherein it is totally covered by water to be treated, and an emerged condition, wherein it emerges, at least partially, from said water to be treated, said apparatus comprising movement means operatively connected to said container for rotating the latter about said rotation axis, said movement means comprising at least one pair of support pins rotationally constrained to the structure of said apparatus.
